(19) United States
(12) Patent Application Publication
(10) Pub. No.: US 2011/0131061 A1
(43) Pub. Date: Jun. 2, 2011

(54) Hospital Patient Chart and Database

(76) Inventor: Joseph Shain, Rehovot (IL)

(21) Appl. No.: 12/958,280

(22) Filed: Dec. 1, 2010

Related U.S. Application Data
(60) Provisional application No. 61/265,841, filed on Dec. 2, 2009.

(51) Int. Cl. G06Q 50/00; G06Q 10/00

(52) U.S. Cl. 705/3

(57) ABSTRACT

An enhanced Livescribe® pen is disclosed and incorporated into a patient record database system. A physician writes patient records on Livescribe® dot paper and the patient records are converted into digital data and transmitted wirelessly to a remote server. The enhanced Livescribe® pen includes an RFID tag reader that reads a patient RFID tag every time a new record in written. The patient ID is transmitted together with the converted written patient records to the remote server.

This application claims priority from U.S. provisional patient application No. 61/265,841 filed Dec. 2, 2009.

### FIELD OF THE INVENTION

The field of the present invention is hospital patient care and more particularly, a method and apparatus for providing hospital charts that enter data written on a chart into an electronic database. The invention uses Livescribe® smartpens and dot paper and similar technology. Livescribe is a trademark or registered trademark of Livescribe corporation of Oakland Calif.

### SUMMARY OF THE INVENTION

The present invention discloses a patient record storage system that includes:

a computer including (a) memory for storing a database of patient records, (b) a processor for writing patient records to said memory, and (c) a wireless communication chip that inputs patient records to the processor;

a plurality of patient charts including dot paper for writing patient records;

a plurality of patient identification (ID) tags placed near respective of said patient charts; and,

a plurality of pens for writing the patient records on the respective patient charts, each pen including (d) a patient ID tag reader for identifying a patient, (e) a pattern recognizer for generating electronic copies of the written patient records, the electronic copies being suitable for storage in the computer memory, and (e) a wireless communication chip in communication with said computer wireless communication chip, for transmitting said patient identity and said electronic copies of the written patient records to the computer for storage in the database of patient records.

In this context the term dot paper includes any paper having a pattern thereon that is used together with an image sensor to determine a location of a pen on the paper. Livescribe™ Dot Paper is one example of such paper.

In certain embodiments of the invention, the patient ID tags are RFID tags.

In certain embodiments of the invention, the pens write in vanishing ink.

The present invention also teaches bundling a wireless communication chip and a radio frequency identification (RFID) tag reader into a Livescribe™ pen and using the pen in a patient record storage system. The system includes:

a computer including (a) memory for storing a database of patient records, (b) a processor for writing patient records to said memory, and (c) a wireless communication chip that inputs patient records to the processor;

a plurality of patient charts including dot paper for writing patient records;

and, a plurality of patient identification (ID) tags placed near respective of said patient charts.

When a user writes a patient record on a patient chart with the pen, the pen RFID tag reader reads data from an RFID tag associated with the patient chart and transmits the RFID tag data and an electronic copy of the written patient record to the computer via the pen wireless communication chip.

The present invention also teaches a method of associating a written record with a patient in a patient database by:

providing a radio frequency identification (RFID) tag in the vicinity of a Livescribe™ Dot paper patient chart;

providing a Livescribe™ pen that includes (a) a detector for detecting an initial contact between the pen and the Livescribe™ Dot paper patient chart, and (b) a radio frequency identification (RFID) tag reader;

activating the RFID tag reader to read the RFID tag when an initial contact between the pen and patient chart is detected;

associate a subsequently written patient record with the RFID tag data.

In certain embodiments, the pen includes a wireless communication chip that communicates with a database server, and the method further includes sending the written patient record and the RFID tag data to the server over the wireless link.

In certain embodiments, the detector is a circuit that can be opened and closed. The circuit includes two connectors separated by a spring connected to the writing tip of the pen. When the spring prevents contact between the two connectors, the circuit is open. When the pen is pressed to paper for writing, the writing tip is pressed thereby compressing the spring and bringing the two connectors into contact with each other. This contact closes the detector circuit.

### BRIEF DESCRIPTION OF THE DRAWINGS

FIG. 1 is a simplified diagram of the database system according to certain embodiments of the present invention;

FIG. 2 is a simplified diagram of the database server according to certain embodiments of the present invention;

FIG. 3 is a simplified diagram of an enhanced Livescribe™ pen according to certain embodiments of the present invention;

FIG. 4 is a simplified diagram of an enhanced Livescribe™ pen including a circuit that is closed by compressing a spring, according to certain embodiments of the present invention;

FIG. 5 s a flow diagram for using the database system of the present invention;

### DETAILED DESCRIPTION

Most hospitals today use handwritten charts posted next to a patient's bed for tracking the patient's status and also for tracking medicines and treatments administered to the patient. With the advent of computers and electronic databases it is advantageous to store this record information electronically. However, several drawbacks prevent this. First, the handwritten log is part of standard procedure at many hospitals. Copying the log to a computer is redundant and requires additional work.

Livescribe corporation has developed a pen that records what is written in a digital format. Features of the Livescribe srnartpen are described in the Livescribedatasheet submitted together with the present specification. Features of the Livescribe srnartpen are also available at www.Livescribe.com.

The Livescribe srnartpen features a high-speed infrared camera with Dot Positioning System (DPS) that tracks everything the user writes, taps, or draws on Livescribe Dot Paper. The DPS not only enables printed controls for recording and playback on each page, but also interactive paper-based applications.

The present invention is a database for monitoring patient care in a hospital. Patient chart paper is Livescribe Dot Paper. The LivescribeM pen is fitted with a wifi wireless connection (or a functionally similar wireless connection, inter alia, Bluetooth) to a central database that enables sending data directly from the pen to the database.

In certain embodiments, the Livescribe pen is fitted with a barcode reader. The attending physician scans a patient's personal barcode before writing to the patient chart. When the barcode is scanned the patient's ID is sent to the database in order that the database append the new data subsequently written by the physician to the appropriate patient record in the database.

Alternatively, a radio frequency identification (RFID) tag is provided near the patient chart that identifies the patient. The pen is equipped with an RFID reader that reads the tag and sends a command to the database to associate the current pen data with the patient's record. One method used in this configuration is to have a computer program that instructs the RFID reader to read the tag every time a Livescribe pen write operation begins. Typically, this occurs every time the Livescribe pen is put to Livescribe Dot Paper. The Livescribe pen does not encode written pen data when the pen is not facing Livescribe Dot Paper. Thus, an event of the pen not facing Livescribe Dot Paper is used in certain embodiments as a program event that that instructs the RFID reader to read the tag when the next Livescribe pen write operation begins. The computer program runs an a processor located inside the pen. Alternatively, the computer program is run on the database hardware and the instructions to read the RFID tag are sent from the database to the pen over wireless connection.

In certain embodiments of the invention, the Livescribe pen uses disappearing ink. This has several applications. One application is to protect confidential information while allowing the writer to see what he is writing. For example, the data on the chart is readable during writing and shortly thereafter. However, once the ink has subsequently disappeared the data cannot be read by anyone. Of course, the data are stored on the database. A database administrator controls access to the data. A second application involves the Jewish Sabbath laws. In a hospital observing the Jewish Sabbath laws it is preferable that patients in no danger (e.g., a woman recuperating after childbirth with no complications) not have their charts written upon during the Sabbath with permanent ink.

Disappearing ink is commonly available and its method of manufacture is well known to those skilled in the art. For example, disappearing ink pens are available at http://www.pimall.com/NAIS/dispen.html. A short description follows. Disappearing ink is a water-based acid-base indicator (pH indicator) that changes from a colored to a colorless solution upon exposure to air. The most common pH indicators for the ink are thymolphthalein (blue) or phenolphthalein (red or pink). The indicators are mixed into a basic solution that becomes more acidic upon exposure to air, causing the color change. Note that in addition to disappearing ink, different indicators make color-change inks, too. When the ink is sprayed onto a porous material the water in the ink reacts with carbon dioxide in the air to form carbonic acid. The carbonic acid then reacts with the sodium hydroxide in a neutralization reaction to form sodium carbonate. Neutralizaton of the base causes a color change of the indicator and the stain disappears:

Carbon dioxide in the air reacts with water to form carbonic acid:

CO₂+H₂O—>H₂CO₃

The neutralization reaction is sodium hydroxide+carbonic acid->sodium carbonate+water:

2Na(OH)+H₂CO₃—>Na₂CO₃+2H₂O

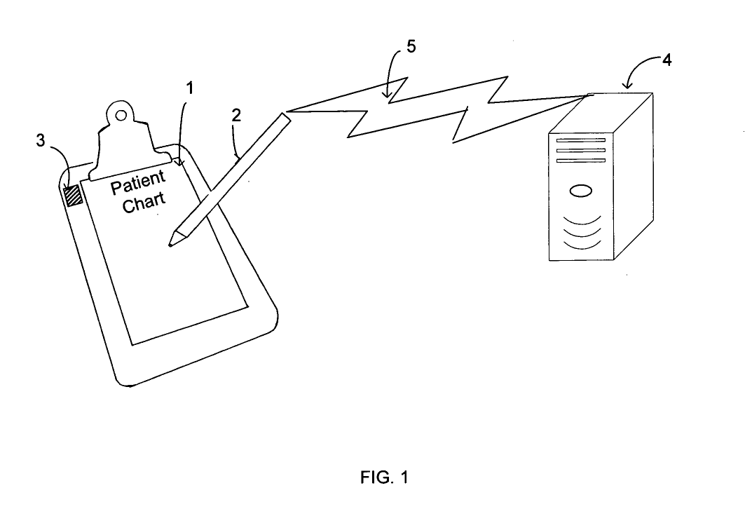

Reference is now made to the figures. FIG. 1 illustrates the database system of the present invention. A doctor writes patient information such as administered drug dosage records on patient chart 1 using enhanced Livescribe™ pen 2. ID tag 3 is affixed to patient chart 1 for identifying the patient. ID tag 3 is a digital ID, inter alia, a bar code or RFID tag. Enhanced Livescribe™ pen 2 is in wireless communication with server 4 indicated in FIG. 1 as wireless communication link 5.

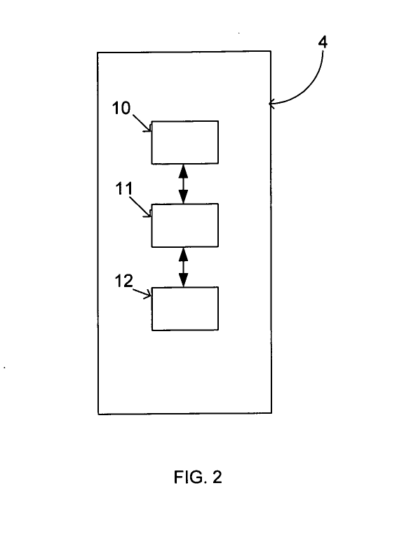

Reference is now made to FIG. 2 illustrating a database server of the present invention. The database server includes memory 10 for storing patient records, CPU 11 for reading and writing patient records and wireless communication chip 12 for wirelessly receiving patient records from Enhanced Livescribe™ pen 2 and sending the received records to CPU 11 for writing to memory 10. Wireless communication chip 12 and memory 10 area shown connected to CPU 11.

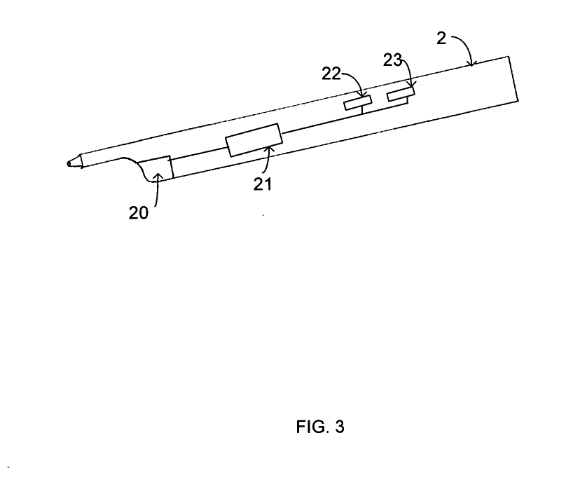

Reference is now made to FIG. 3 illustrating an enhanced Livescribe™ pen 2 according to the teachings of the present invention. Enhanced Livescribe™ pen 2 includes image sensor 20 for detecting a dot pattern on dot-pattern paper. Images are stored in memory 21. These images enable cpu 22 to determine the pen strokes performed on the dot-paper. Wireless communicator chip 23 transfers patient records from memory 21 to remote server 4.

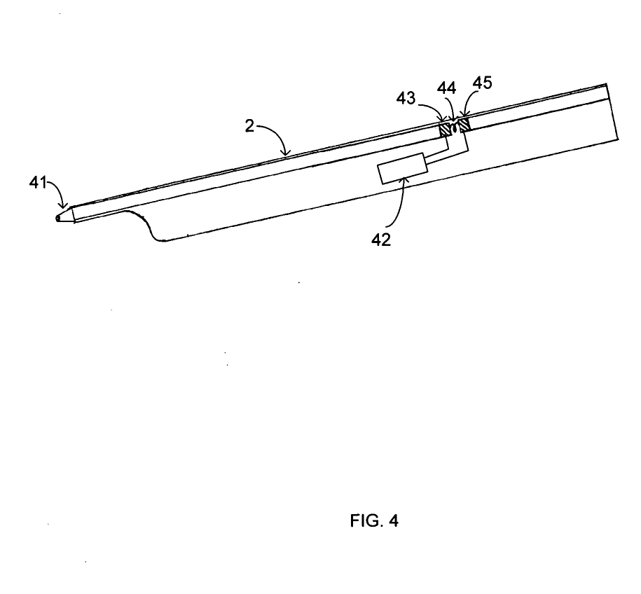

Reference is now made to FIG. 4 illustrating an enhanced Livescribe pen 2 according to the teachings of the present invention. Enhanced Livescribe pen 2 includes pen nib 41 at one end of a shaft or ink cartridge. At the other and is a first connector 43. A detector circuit is closed when connectors 43 and 45 are in contact with each other. The detector circuit includes integrated circuit (IC) 42 and connectors 43 and 45. Spring 44 separates connectors 43 and 45, leaving the circuit open. However, when the pen is put to paper, nib 41 is pushed into the pen casing compress's spring 44 and closing the circuit. This indicates that a write operation has commenced. According to certain embodiments, this triggers a program running on CPU 22 to execute an RFID tag reader routine and send the tag ID data together with the written patient records to remote server 4.

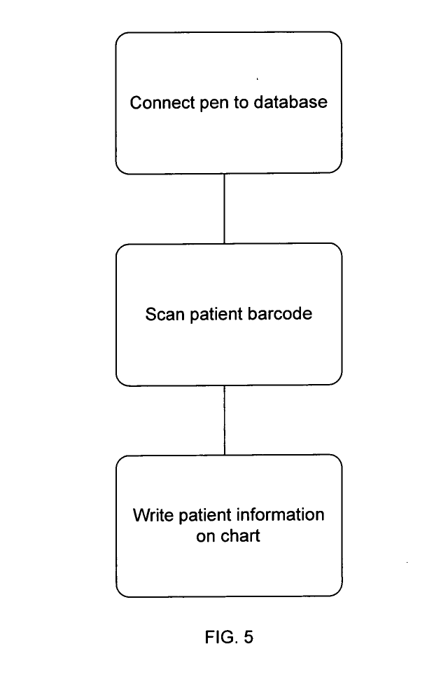

Reference is now made to FIG. 5 showing a flow chart of the use of the present invention according to certain embodiments. The first step is to connect the pen to the database over wireless connection. There are many ways to accomplish this, known to those skilled in the art. One method is that each pen is provided a unique identifier, similar to a computer mac address. This unique identifier is sent to the database and the database is configured to accept and store data sent from the pen based on the unique identifier.

The second step is to communicate to the database which patient record to select. This can be done in many ways, known to those skilled in the art of database design. One method is to append a bar code scanner to the pen and scan a patient barcode. Many hospitals today use barcodes to identify patients. Another method is to use the image sensor in the pen to capture an image of the barcode and send the image to the database. The database runs a program that decodes the barcode image and retrieves the appropriate patient record. According to this second method a barcode reader is not included in the pen. In certain embodiments, a user interface, such as a button, is provided on the pen. Through the user interface, e.g., by pressing a button on the pen body, the user indicates to the database that he is taking a picture of the patient barcode. The database thereby activates an appropriate barcode decoder function and subsequently calls a record selection query to select the corresponding patient record.

The third step is to write data on the chart. The chart is comprised of Livescribe™ Dot Paper. The pen therefore records whatever is written and transmits the written information to the database where it is appended to the active patient's record.

As the physician proceeds from one patient to the next, he performs steps two (select new patient) and three (enter new patient data). When a new patient is selected, if a patient record is already open, the open patent record is closed and the new patient record is opened.

According to further features of the invention, audio is also recorded by the pen and associated with the written record in the database.

The present invention is also useful in a physician's office. In this case, the physician enters and stores his paper files, maintaining their continuity, while saving all new entries into a parallel database for protection and backup in case the paper files are destroyed, for example by fire on flood. In addition, the electronic file is easily transferred, for example, if the patient transfers to a different physician. In this case, there is also no problem in providing the new physician with a complete patient record without the former physician losing the original.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1. A patient record storage system comprising:
(i) a computer including (a) memory for storing a database of patient records, (b) a processor for writing patient records to said memory, and (c) a wireless communication chip that inputs patient records to the processor;
(ii) a plurality of patient charts including dot paper for writing patient records;
(iii) a plurality of patient identification (ID) tags placed near respective of said patient charts; and,
(iv) a plurality of pens for writing the patient records on the respective patient charts, each pen including (d) a patient ID tag reader for identifying a patient, (e) a pattern recognizer for generating electronic copies of the written patient records, the electronic copies being suitable for storage in the computer memory, and (e) a wireless communication chip in communication with said computer wireless communication chip, for transmitting said patient identity and said electronic copies of the written patient records to the computer for storage in the database of patient records.

2. The patient record storage system of claim 1, wherein the patient ID tags are RFID tags.

3. The patient record storage system of claim 1, wherein the pens write in vanishing ink.

4. The use of a Livescribe pen comprising a wireless communication chip and a radio frequency identification (RFID) tag reader in a patient record storage system, the system comprising:
(i) a computer including (a) memory for storing a database of patient records, (b) a processor for writing patient records to said memory, and (c) a wireless communication chip that inputs patient records to the processor;
(ii) a plurality of patient charts including dot paper for writing patient records;
(iii) a plurality of patient identification (ID) tags placed near respective of said patient charts,
wherein when a user writes a patient record on a patient chart with the Livescribe pen, the pen RFID tag reader reads data from an RFID tag associated with the patient chart and transmits the RFID tag data and an electronic copy of the written patient record to the computer via the pen wireless communication chip.

5. A method of associating a written record with a patient in a patient database, the method comprising:
(i) providing a radio frequency identification (RFID) tag in the vicinity of a Livescribe dot paper patient chart;
(ii) providing a Livescribe pen that includes (a) a detector for detecting an initial contact between the pen and the Livescribe dot paper patient chart, and (b) a radio frequency identification (RFID) tag reader;
(iii) activating the RFID tag reader to read the RFID tag when an initial contact between the pen and patient chart is detected;
(iv) associate a subsequently written patient record with the RFID tag data.

6. The method of claim 5, wherein the pen further comprises a wireless communication chip that communicates with a database server, the method further comprising sending the written patient record and the RFID tag data to the server over the wireless link.

7. The method of claim 5, wherein the detector comprises a circuit having two connectors separated by a spring connected to the writing tip of the pen, wherein when the writing tip is pressed the spring compresses to connect the two connecters closing the detector circuit.
